(19) United States
(12) Patent Application Publication
(10) Pub. No.: US 2008/0233330 A1
(43) Pub. Date: Sep. 25, 2008

(54) SILICON SUBSTRATE FOR MAGNETIC RECORDING MEDIA AND METHOD OF FABRICATING THE SAME

(75) Inventor: Ken Ohashi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 12/050,504

(22) Filed: Mar. 18, 2008

(30) Foreign Application Priority Data
Mar. 19, 2007 (JP) 2007-071337

(51) Int. Cl. B32B 3/30; B44C 1/22; G11B 5/82

(52) U.S. Cl. 428/64.4; 216/38

(57) ABSTRACT

A liquid material containing a silicone material or organosilica is applied to a roughly polished surface of a polycrystalline silicon substrate to form a smooth thin film covering steps and grain boundary portions; thereafter, the thin film is subjected to a heat treatment at an appropriate temperature to allow the organic components thereof to evaporate off, thereby forming an SiO₂ film; and the resulting SiO₂ film is then subjected to precision polishing, such as a CMP process, to impart the substrate with a high planarity. This method makes it possible to give a planar and smooth surface with no effect reflecting differences in crystal orientation among polycrystalline grains or the presence of grain boundaries. The Si substrate for magnetic recording media thus obtained exhibits a sufficient impact resistance and an excellent surface planarity.

### BACKGROUND OF THE INVENTION

1. Field of the Invention

The present invention relates to a silicon substrate for use in producing magnetic recording media, and a method of fabricating the same.

2. Description of the Related Art

In the technical field of information recording, a hard disk device for magnetically reading/writing such information as letters, images, and music is now indispensable as a primary external storage device or built-in type recording means for use with or in electronic devices including a personal computer. Such a hard disk device incorporates therein a hard disk as a magnetic recording medium. Conventional hard disks have employed the so-called “in-plane magnetic recording system (longitudinal magnetic recording system)” which is configured to write magnetic information on a disk surface longitudinally.

FIG. 1(A) is a schematic sectional view illustrating a typical stacked layer structure for a hard disk of the longitudinal magnetic recording system. This structure includes a Cr-based underlayer 2 formed by sputtering, magnetic recording layer 3, and carbon layer 4 as a protective layer, which are sequentially stacked on a non-magnetic substrate 1, and a liquid lubricating layer 5 formed by applying a liquid lubricant to the surface of the carbon layer 4 (see Japanese Patent Laid-Open No. 5-143972 (Patent Document 1) for example).

The magnetic recording layer 3 comprises a uniaxial magnetocrystalline anisotropic Co alloy, such as CoCr, CoCrTa, or CoCrPt. Crystal grains of the Co alloy are magnetized longitudinally of the disk surface to record information. The arrows in the magnetic recording layer 3 shown indicate directions of magnetization.

With such a longitudinal magnetic recording system, however, when individual recording bits are reduced in size to increase the recording density, the north pole and south pole of a recording bit repel the north pole and south pole, respectively, of an adjacent recording bit, to make the boundary region magnetically unclear. For this reason, it is necessary to reduce the thickness of the magnetic recording layer so as to reduce the crystal grain size for the purpose of realizing a higher recording density. As crystal grains are made more minute (i.e., reduced in volume) and recording bits made smaller in size, it is pointed out that a phenomenon called “heat fluctuation” occurs to disorder directions of magnetization of crystal grains by thermal energy, thereby to cause a loss of recorded data. Thus, the increase in the recording density has been considered to be limited. The effect of the heat fluctuation becomes serious when the KuV/k_{B}T ratio is too low, where Ku represents magnetocrystalline anisotropic energy of a recording layer, V represents the volume of a recording bit, k_{B} represents a Boltzmann constant, and T represents an absolute temperature (K).

In view of such a problem, the “perpendicular magnetic recording system” is now studied. With this recording system, the magnetic recording layer is magnetized perpendicularly to the disk surface, so that north poles and south poles are alternately arranged as bound one with the other in recording bits. Therefore, a north pole and a south pole in a magnetic domain are positioned adjacent to each other, to strengthen the mutual magnetization. As a result, the magnetized state (i.e., magnetic recording) is highly stabilized. When a magnetization direction is recorded perpendicularly, a demagnetizing field of a recording bit is weakened. For this reason, the perpendicular magnetic recording system does not need to have a very thin recording layer, as compared with the longitudinal magnetic recording system. Accordingly, if the recording layer is thickened to ensure a larger perpendicular dimension, the recording layer, as a whole, has an increased KuV/k_{B}T ratio, thereby making it possible to reduce the effect of the “heat fluctuation”.

Since the perpendicular magnetic recording system is capable of weakening the demagnetizing field and ensuring a satisfactory KuV value as described above, the perpendicular magnetic recording system can lower the instability of magnetization due to the “heat fluctuation” thereby making it possible to expand a margin of recording density substantially. Therefore, the perpendicular magnetic recording system is expected to realize ultrahigh density recording.

FIG. 1(B) is a schematic sectional view illustrating a basic layered structure for a hard disk as a “double-layered perpendicular magnetic recording medium” having a recording layer for perpendicular magnetic recording which is stacked on a soft magnetic backing layer. This structure includes a soft magnetic backing layer 12, magnetic recording layer 13, protective layer 14, and lubricating layer 15, which are sequentially stacked on a non-magnetic substrate 11. Here, the soft magnetic backing layer 12 typically comprises permalloy, amorphous CoZrTa, or a like material.

The magnetic recording layer 13 comprises a CoCrPt alloy, a CoPt alloy, a multi-layered film formed by alternately stacking several layers including a PtCo layer and ultrathin films of Pd and Co, an amorphous PtFe or SmCo film, or the like. The arrows in the magnetic recording layer 13 shown indicate directions of magnetization.

The hard disk of the perpendicular magnetic recording system includes the soft magnetic backing layer 12 underlying the magnetic recording layer 13, as shown in FIG. 1(B). The soft magnetic backing layer 12, which has a magnetic property called “soft magnetic”, has a thickness of about 100 to about 200 nm. The soft magnetic backing layer 12 is provided for enhancing the writing magnetic field and weakening the demagnetizing field of the magnetic recording film and functions as a path which allows a magnetic flux to pass from the magnetic recording layer 13 while allowing a magnetic flux for writing to pass from the recording head.

That is, the soft magnetic backing layer 12 functions like an iron yoke provided in a permanent-magnet magnetic circuit. For this reason, the thickness of the soft magnetic backing layer 12 has to be set larger than that of the magnetic recording layer 13 for the purpose of avoiding magnetic saturation during writing.

Longitudinal magnetic recording systems as shown in FIG. 1(A) are gradually replaced with perpendicular magnetic recording systems as shown in FIG. 1(B) as the recording density increases from a border which ranges from 100 to 150 Gbit/square inch because the longitudinal magnetic recording system has a limited recording density due to the heat fluctuation. Though the recording limit of the perpendicular magnetic recording system remains uncertain at present, it must be certain that the recording limit is not less than 500 Gbit/square inch. In another view, the perpendicular magnetic recording system can achieve a recording density as high as about 1000 Gbit/square inch. Such a high recording density can provide for a recording capacity of 600 to 700 Gbits per 2.5-in. HDD platter.

Substrates generally used in magnetic recording media for HDDs include an Al alloy substrate used as a substrate having a diameter of 3.5 inches, and a glass substrate used as a substrate having a diameter of 2.5 inches. In mobile applications such as a notebook personal computer, in particular, HDDs are likely to frequently undergo impacts from outside. Therefore, a 2.5-in. HDD used in such a mobile application has a high possibility that its recording medium or substrate is damaged or data destroyed by collision of the magnetic head. For this reason, a glass substrate having a high hardness has been used as a substrate for magnetic recording media.

As a mobile device is reduced in size, a substrate for use in a magnetic recording medium to be incorporated therein calls for a higher impact resistance. Substrates having small diameters of not more than 2 inches are mostly used in mobile applications and hence call for a higher impact resistance than 2.5-in. substrates. Also, the downsizing of such a mobile device inevitably calls for downsizing and reducing the thickness of parts to be used therein. A standard thickness of a substrate having a diameter of 2.5 inches is 0.635 mm, whereas that of a substrate having a diameter of, for example, 1 inch is 0.382 mm. In view of such circumstances, a demand exists for a substrate which has a high Young's modulus, ensures a sufficient strength even when made thin, and offers good compatibility with the magnetic recording medium fabrication process.

Though a glass substrate having a diameter of 1 inch and a thickness of 0.382 mm has been put to practical use by mainly using reinforced amorphous glass, further thinning is not easy. Further, since a glass substrate is an insulator, a problem arises that the substrate is likely to be charged up during formation of a magnetic film by sputtering. Though volume production of such substrates is made practically possible by changing a holder holding a substrate to another one during sputtering, this problem is one of the factors making the use of a glass substrate difficult.

Study has been made of FePt or the like as a material for a next-generation recording film. Such an FePt film needs to be heat-treated at a high temperature of about 600° C. so as to have a higher coercive force. Though attempts have been made to lower the heat treatment temperature, a heat treatment at a temperature of not lower than 400° C. is still needed. Such a temperature exceeds the temperature at which currently used glass substrates can resist. Likewise, Al substrates cannot resist such a high temperature treatment.

Besides such glass substrate and Al substrate, alternative substrates have been proposed which include a sapphire glass substrate, SiC substrate, engineering plastic substrate, and carbon substrate. However, the realities are such that any one of such substrates is inadequate for use as an alternative substrate for a small-diameter substrate in view of its strength, processability, cost, surface smoothness, affinity for film formation, and like properties.

Against the backdrop of such circumstances, the inventors of the present invention have already proposed use of a single crystal silicon (Si) substrate as an HDD recording film substrate (see Japanese Patent Laid-Open No. 2005-108407 (Patent Document 2) for example).

Such a single crystal Si substrate, which is widely used as a substrate for LSI fabrication, is excellent in surface smoothness, environmental stability, reliability, and the like and has a higher rigidity than glass substrates. For this reason, the single crystal Si substrate is suitable for an HDD substrate. In addition, unlike glass substrates having insulating properties, the single crystal Si substrate is semiconductive and has a certain electric conductivity because the single crystal Si substrate is usually doped with a p- or n-type dopant.

Thus, the single crystal Si substrate can lessen the charge-up which occurs during film formation by sputtering to a certain extent and allows a metal film to be formed by direct sputtering or bias sputtering. Further, since the single crystal Si substrate has good thermal conductivity, the Si crystal substrate can be easily heated and has a very good compatibility with the sputtering process for film formation. What is more, the Si substrate has the advantage that its crystal purity is very high and its substrate surface obtained after processing is stable with a negligible change with time.

However, Si single crystals of the “semiconductor grade” for fabrication of such devices as LSIs are generally expensive. In fact, the price of Si single crystals of “the semiconductor grade” are soaring with increasing demand due to solar cells widespread in recent years. When consideration is given to use of the single crystal Si substrate as a substrate for magnetic recording media, a serious problem arises that the single crystal Si substrate becomes inferior to glass substrates or Al substrates in terms of raw material cost as its diameter increases.

The single crystal Si substrate has the property of cleaving in a specific crystal orientation plane (110). For this reason, when the single crystal Si substrate used in a mobile device or the like undergoes an external impact, the substrate might cleave. In this respect, the inventors of the present invention have confirmed that no practical problem will arise if end face polishing is improved. However, the concern about fracture cannot be eliminated.

### SUMMARY OF THE INVENTION

The present invention has been made in view of the foregoing problems. Accordingly, it is an object of the present invention to provide an Si substrate for magnetic recording media which has a sufficient impact resistance, fails to complicate the fabrication process and the film forming process for a magnetic recording layer, exhibits an excellent surface planarity, and allows the cost to be reduced.

In order to solve the foregoing problems, a silicon substrate for magnetic recording media according to the present invention comprises: a polycrystalline silicon substrate having a purity of not less than 99.99%, and an oxide film formed over a major surface of the polycrystalline silicon substrate, wherein the oxide film forms a substrate surface having a mean square waviness value and a mean square microwaviness value which are both not more than 0.3 nm.

The silicon substrate according to the present invention has a diameter of not more than 90 mm for example, and the oxide film has a thickness of not more than 1,000 nm and not less than 10 nm.

By providing a magnetic recording layer on such a silicon substrate, a magnetic recording medium according to the present invention can be provided.

A method of fabricating a silicon substrate for magnetic recording media according to the present invention comprises the steps of: forming an oxide film over a major surface of a polycrystalline silicon substrate having a purity of not less than 99.99%; and polishing the oxide film to planarize the oxide film, wherein the oxide film forming step includes applying organic silica or a silicone material to the major surface of the polycrystalline silicon substrate by spin coating and then performing a heat treatment, or thermally oxidizing the major surface of the polycrystalline silicon substrate.

Preferably, the polishing step includes subjecting the oxide film to a CMP process using a neutral or alkaline slurry so that a resulting substrate surface has a mean square waviness value and a mean square microwaviness value which are both not more than 0.3 nm.

According to the present invention, a liquid material containing a silicone material or organosilica is applied to a roughly polished surface of a polycrystalline silicon substrate to form a smooth thin film covering steps and grain boundary portions; thereafter, the thin film is subjected to a heat treatment at an appropriate temperature to allow the organic components thereof to evaporate off, thereby forming an SiO₂ film; and the resulting SiO₂ film is then subjected to precision polishing, such as a CMP process, to impart the substrate with a high planarity. This method makes it possible to give a planar and smooth surface with no effect reflecting differences in crystal orientation among polycrystalline grains or the presence of grain boundaries.

Thus, it becomes possible to provide an Si substrate for magnetic recording media which has a sufficient impact resistance, fails to complicate the fabrication process and the film forming process for a magnetic recording layer, exhibits an excellent surface planarity, and allows the cost to be reduced.

### BRIEF DESCRIPTION OF THE DRAWINGS

FIG. 1(A) is a schematic sectional view illustrating a typical stacked layer structure for a hard disk of the longitudinal magnetic recording system;

FIG. 1(B) is a schematic sectional view illustrating a basic layered structure for a hard disk as a “double-layered perpendicular magnetic recording medium” having a recording layer for perpendicular magnetic recording which is stacked on a soft magnetic backing layer;

FIG. 2 is a flowchart illustrating an exemplary process for fabricating an Si substrate for magnetic recording media according to the present invention;

FIG. 3(A) is a graphic representation illustrating an exemplary evaluation of the waviness of a polycrystalline Si substrate surface having been polished;

FIG. 3(B) is a graphic representation illustrating an exemplary evaluation of the roughness of a polycrystalline Si substrate surface having been polished; and

FIG. 4 is a graphic representation illustrating an exemplary evaluation of the waviness of a polycrystalline Si substrate surface obtained according to the method of the present invention.

### DESCRIPTION OF THE PREFERRED EMBODIMENTS

Hereinafter, embodiments of the present invention will be described in detail with reference to the drawings.

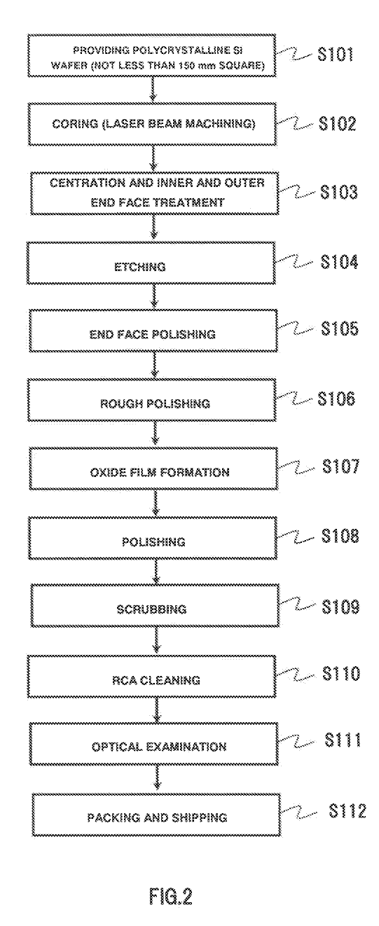

FIG. 2 is a flowchart illustrating an exemplary process for fabricating an Si substrate for magnetic recording media according to the present invention. First, a polycrystalline Si wafer is provided from which an Si substrate is obtained by coring (step S101). Such a polycrystalline Si wafer need not have the so-called “semiconductor grade” (which generally has a purity of “11 nines” (99.999999999%) or higher). It is sufficient for the polycrystalline Si wafer to have substantially the “solar grade”.

Though the purity of a polycrystalline Si wafer having the solar grade is generally not less than “6 nines” (99.9999%), the present invention can tolerate a purity down to “4 nines” (99.99%). Because the Si substrate is basically used as a structural material in an application of the substrate for magnetic recording, there is no need to control the dose of a dopant, such as boron (B) or phosphorus (P), unlike in an application for solar cell.

The lower limit of the purity of the polycrystalline Si wafer is set to “5 nines” because a lower purity than the lower limit allows an impurity contained in the crystal to precipitate in grain boundaries, thereby to lower the strength of the substrate. Though a polycrystalline Si wafer having a higher purity is more preferable from the viewpoint of the substrate strength and the like, the raw material cost increases as the purity becomes higher. For this reason, the purity of the polycrystalline Si wafer is usually about “8 nines” (99.999999%) to about “9 nines” (99.9999999%).

The polycrystalline Si wafer may be shaped rectangular or like a disc. A rectangular shape is more preferable from the viewpoint of yield. Polycrystalline Si wafers for solar cells are generally shaped into an about 150 mm square. For this reason, an exemplary process illustrated in FIG. 2 employs a polycrystalline Si wafer of such a shape. In improving the strength and impact resistance of a polycrystalline Si wafer itself, it is critical to take an average grain size of polycrystalline grains into consideration. Desirably, the average grain size is not less than 1 mm and not more than 15 mm.

The polycrystalline Si substrate is obtained from such a polycrystalline Si wafer by “coring” by laser beam machining (step S102). In the present invention, the polycrystalline Si substrate is expected to be used mainly as an Si substrate for magnetic recording media applied to mobile devices. For this reason, the diameter of the Si substrate thus cored is not more than about 90 mm, and the lower limit of the diameter of the Si substrate is generally 21 mm.

The coring can be achieved by various methods including cutting using a straight cup diamond wheel, ultrasonic cutting, blasting, and water jet cutting. Laser coring using a solid state laser is desirable because the laser coring has advantages including: a certain cutting speed ensured, the width of cut reduced, easy change of diameter, and ease of jig making and post-processing. Since such a solid state laser has a high power density and can reduce the beam diameter, a cut surface obtained by the solid state laser is relatively clear with less dross. Laser light sources for use in such a case include Nd-YAG laser, Yb-YAG laser, and the like.

The Si substrate thus obtained by coring is subjected to centration and inner and outer end face treatment (step S103). Further, the Si substrate is subjected to etching to remove a layer damaged by machining (step S104) and then subjected to end face polishing so as to prevent chipping and the like from occurring during later polishing (step S105).

The Si substrate thus obtained is subjected to rough polishing so as to have a substantially planarized surface. The rough polishing step is equivalent to the “rough polishing” (step S106) illustrated in FIG. 2. In the present invention, the rough polishing for surface smoothing is achieved by a CMP process using a neutral or alkaline slurry.

Generally, the surface of a single crystal Si substrate is smoothed by a multi-stage CMP process using an alkaline slurry. However, the Si substrate to be provided by the present invention comprises polycrystalline silicon having different crystal orientations grain by grain. For this reason, if the CMP process is carried out using an alkaline slurry, the resulting surface cannot have a satisfactory surface planarity because of the polishing speed varying grain by grain. For this reason, pH adjustment is necessary in carrying out the rough polishing for surface smoothing using a neutral to alkaline slurry.

Specifically, the CMP process employed in the present invention uses a slurry of colloidal silica having a pH value ranging from a value near neutral to an alkaline region (pH 7 to pH 10). When the pH value exceeds pH 10, steps defined between grains become too large. When the pH value is not more than pH 7, mechanical polishing becomes predominant and, hence, the polishing speed becomes too low. Adding to a slurry an oxidizing agent or coating material used in a CMP process for an interlayer insulator of an LSI is effective.

The CMP process using alkaline colloidal silica of pH 9 for example is performed as the rough polishing step (S106). The rough polishing step is intended to roughly eliminate thickness irregularities and steps on the surface of the polycrystalline Si substrate. The rough polishing step simply ensures a certain planarity of the Si substrate surface and hence can leave minute flaws on the substrate surface.

Subsequently, an oxide film (SiO₂ film) is formed over the Si substrate surface thus roughly polished (step S107). The provision of the SiO₂ film on the substrate surface makes it possible to enhance the strength and impact resistance of the intended substrate because the strength of the thin substrate can be enhanced by the film formed thereon while the SiO₂ film, which is amorphous, fails to cleave in a specific orientation. According to the present invention, the oxide film formation is performed using a liquid material containing organosilica (organic silica) or a silicone material.

Specifically, the liquid material containing a silicone material or organosilca is applied to the Si substrate surface to form a smooth thin film, which is then subjected to a heat treatment at an appropriate temperature to allow organic components thereof to evaporate off, thus giving the SiO₂ film. Of course, the SiO₂ film may be formed by thermal oxidation employed in a common semiconductor process. When the thickness of the intended SiO₂ film is relatively large, for example, not less than 100 nm, the thermal oxidation treatment tends to take a relatively long time. For this reason, the SiO₂ film formation by the above-described coating method is more desirable from the viewpoint of process cost and productivity.

Examples of silicon sources for such oxide film formation include a hydrolytic condensate (for example, Accuflo T-27 produced by Honeywell, Accuglass P-5S produced by ALLIED SIGNAL, or the like) prepared by hydrolyzing and condensing a silane compound (particularly alkoxysilane).

Such a film of organosilica or silicone material is uniformly applied to the substrate surface by, for example, spin coating to have a thickness of not less than 100 nm and then subjected to a heat treatment at a temperature of not lower than 400° C., thus giving the SiO₂ film. Though depending on the kind of coating material used and the spin coating conditions, the thickness of the SiO₂ film thus obtained is generally about 100 nm to about 700 nm. Since the method employed includes applying the liquid material to the substrate surface, spin coating with the liquid material can provide a planar coating surface covering steps and grain boundary portions left on the Si substrate surface as long as the Si substrate surface having been subjected to the rough polishing (step S106) has a certain degree of planarity or higher (for example, steps defined between grains each measure not more than 10 nm and the waviness Wa is not more than about 2.0 nm).

Examples of silane compounds for use as silicon sources include methyltrimethoxysilane, methyltriethoxysilane, methyltri-n-propoxysilane, methyltri-iso-propoxysilane, ethyltrimethoxysilane, ethyltriethoxysilane, phenyltrimethoxysilane, phenyltriethoxysilane, tetramethoxysilane, tetraethoxysilane, dimethyldimethoxysilane, dimethyldiethoxysilane, diethyldimethoxysilane, diethyldiethoxysilane, diphenyldimethoxysilane, diphenyldiethoxysilane, hexamethoxydisilane, hexaethoxydisilane, 1,1,2,2-tetramethoxy-1,2-dimethyldisilane, 1,1,2,2-tetraethoxy-1,2-dimethyldisilane, 1,1,2,2-tetramethoxy-1,2-diphenyldisilane, 1,2-dimethoxy-1,1,2,2-tetramethyldisilane, 1,2-diethoxy-1,1,2,2-tetramethyldisilane, 1,2-dimethoxy-1,1,2,2-tetraphenyldisilane, 1,2-diethoxy-1,1,2,2-tetraphenyldisilane, bis(trimethoxysilyl)methane, bis(triethoxysilyl)methane, 1,2-bis(trimethoxysilyl)ethane, 1,2-bis(triethoxysilyl)ethane, 1-(dimethoxymethylsilyl)-1-(trimethoxysilyl)methane, 1-(diethoxymethylsilyl)-1-(triethoxysilyl)methane, 1-(dimethoxymethylsilyl)-2-(trimethoxysilyl)ethane, 1-(diethoxymethylsilyl)-2-(triethoxysilyl)ethane, bis(dimethoxymethylsilyl)methane, bis(diethoxymethylsilyl)methane, 1,2-bis(dimethoxymethylsilyl)ethane, 1,2-bis(diethoxymethylsilyl)ethane, 1,2-bis(trimethoxysilyl)benzene, 1,2-bis(triethoxysilyl)benzene, 1,3-bis(trimethoxysilyl)benzene, 1,3-bis(triethoxysilyl)benzene, 1,4-bis(trimethoxysilyl)benzene, and 1,4-bis(triethoxysilyl)benzene. Two or more of these silane compounds may be used in combination.

Examples of solvents for dissolving such a silane compound therein include alcohols such as ethyl alcohol and isopropyl alcohol, aromatic hydrocarbons such as benzene and toluene, alkanes such as n-heptane and dodecane, ketones, esters, glycol ethers, and cyclic dimethyl polysiloxane.

The temperature at which organosilica or silicone material is heat-treated is generally within a range from 400° C. to 500° C. for 10 minutes or longer, though depending on the kind of material applied. Rapid heating (at a rate of 100° C./min for example) is possible to such an extent as not cause surface chapping. The heat treatment atmosphere is usually air, but an inert gas atmosphere may be used.

Subsequent to such oxide film formation, the SiO₂ film is polished (step S108). This polishing step may be performed in plural stages. The polishing step is a step for imparting the SiO₂ film with a surface planarity. The polishing step employs the CMP process combining polishing by chemical action and polishing by mechanical action. The polishing step removes a portion of the SiO₂ film that has an appropriate thickness. Thus, the polishing step makes the SiO₂ film, which is usually about 100 to about 700 nm thick before polishing, have a thickness of 10 to 1,000 nm for example.

Generally, when a bare surface of a polycrystalline Si substrate is subjected to the CMP process, steps are formed due to differences in polishing speed among crystal grains having different crystal orientations. According to the present invention, however, there is absolutely no fear of formation of such steps by virtue of the formation of the above-described SiO₂ film on the surface of the polycrystalline Si substrate. Accordingly, it is possible to obtain a good polycrystalline Si substrate surface with a low surface roughness Ra and less minute defects. Furthermore, since the SiO₂ film is formed over the roughly polished surface which has been substantially planarized, a finally smoothed surface can be obtained by performing polishing for a relatively short time.

As described above, the oxide film is formed over the substrate surface at an appropriate stage during processing of the polycrystalline Si substrate according to the present invention. For this reason, the CMP process can provide a planar and smooth surface with not effect reflecting differences in crystal orientation among polycrystalline grains or the presence of grain boundaries. Also, the provision of the oxide film makes it possible to fabricate the polycrystalline Si substrate which is also excellent in mechanical strength.

The slurry used in the CMP process performed in each of the rough polishing step (S106) and the polishing step (S108) is usually a common one. For example, a slurry of colloidal silica having an average particle diameter of 20 to 80 nm is used with its pH value adjusted into an alkaline region from pH 7 to pH 10. The pH adjustment is achieved by addition of hydrochloric acid, sulfuric acid, hydrofluoric acid, or the like. The CMP process is performed for about 5 minutes to about one hour to attain a desired surface smoothness by using the slurry in which colloidal silica is dispersed in a concentration of about 5% to about 30%. Particularly, the rough polishing (step S106) and the polishing (step S108) are performed preferably at a polishing pressure of 5 to 20 kg/cm² and a polishing pressure of 1 to 10 kg/cm², respectively.

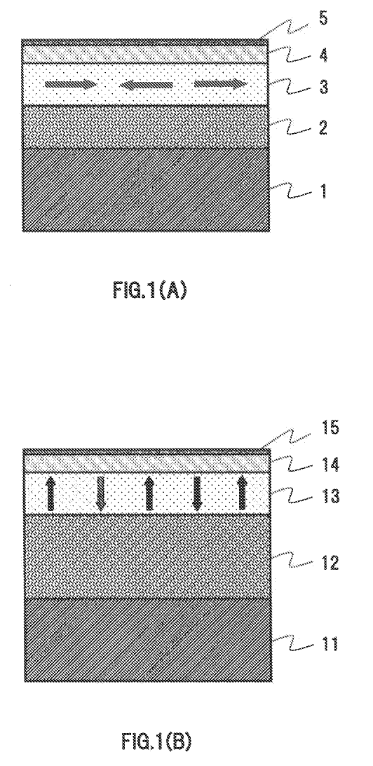

Subsequent to the polishing step (S108), scrubbing (step S109) and RCA cleaning (step S110) are performed to clean the substrate surface. Thereafter, the substrate surface is optically examined (step S111), and then the Si substrate is packed and shipped (step S112). By forming a magnetic recording layer on the thus obtained polycrystalline Si substrate formed with the oxide film, a magnetic recording medium can be obtained having a stacked layer structure as shown in FIG. 1(B).

The polycrystalline Si substrate thus obtained has a means square waviness value and a mean square microwaviness value which are both not more than 0.3 nm. Thus, the polycrystalline Si substrate has adequate surface properties for a hard disk substrate. By providing a magnetic recording layer on such an Si substrate, a magnetic recording medium is obtained.

Hereinafter, the present invention will be described more specifically by way of examples, which in no way limit the present invention.

### EXAMPLES

A polycrystalline Si wafer having a purity of “6 nines” (156 mm square and 0.6 mm thick) was provided (step S101). Nine substrates were obtained per wafer by coring Si substrates each having an outer diameter of 48 mm and an inner diameter of 12 mm from the polycrystalline Si wafer with use of a laser beam machine (YAG laser, wavelength: 1064 nm) (step S102). These substrates were subjected to centration and inner and outer end face treatment (step S103), etching (step S104), and end face polishing (step S105).

Subsequently, the major surface of each polycrystalline Si substrate was subjected to the rough polishing process (step S106). The rough polishing process was performed at a polishing pressure of 10 kg/cm² for 20 minutes using a double-side polishing machine and a slurry of average colloidal silica of pH 9 (particle diameter: 30 nm). Steps on the roughly polished major surface of each polycrystalline Si substrate which were defined between grains, generally measured about 2 nm according to measurement by an optical testing device (Zygo).

After having subjected the roughly polished substrates to scrubbing, organosilica (aforementioned Accuflo-T-27 or Accuglass P-5S) was applied to the substrates under different conditions and then heated at 400° C. for 30 minutes to form an SiO₂ film on each substrate. According to measurement by a film thickness tester, the SiO₂ films generally had thicknesses of about 100 to about 600 nm and exhibited uniform thickness distributions in plane. Steps resulting from the rough polishing (step S106) (including steps defined between grains and steps caused by grain boundaries) were covered with the SiO₂ film, so that a high planarity was ensured.

Subsequently, the CMP process (step S108) was performed at a polishing pressure of 5 kg/cm² using fine particle colloidal silica for finishing (pH value: 10, particle diameter: 40 nm), to abrade each SiO₂ film to a depth of 50 to 300 nm from the surface of the SiO₂ film. Thus, a smooth polished surface with no minute defect resulted. Here, the abrasion wear was varied in accordance with the thicknesses of the SiO₂ films (i.e., initial coat thicknesses of organosilica).

These polycrystalline Si substrates were subjected to scrubbing (step S109) to remove residual colloidal silica and then subjected to precision cleaning (i.e., RCA cleaning: step S110). The surface properties of each of the Si substrates thus cleaned were evaluated by optical examination (step S111). That is, the warpage and smoothness of the polished surface of each substrate were evaluated. (Specifically, the waviness and the microwaviness of the polished surface were measured using Opti-Flat manufactured by Phase Shifter Co. and an optical measuring device manufactured by Zygo Co., respectively, while the roughness of the polished surface measured by an AFM apparatus manufactured by Digital Instrument Co.)

Table 1 shows the results of evaluation of the samples of examples 1 to 4 thus obtained (Ra: roughness, Wa: waviness, and μ-Wa: microwaviness). Table 1 also shows the result of evaluation of a sample uncoated with an SiO₂ film (no coat) as a comparative example.

As can be seen from this table, the polycrystalline Si substrates each formed with an SiO₂ film, which were obtained by the method of the present invention, had good surface properties, and any step reflecting a crystal grain distribution was not observed which can be observed when the CMP process is performed on a bare surface of a polycrystalline Si substrate using colloidal silica having a relatively high alkalinity (for example pH 12). The surface of the sample prepared as the comparative example (i.e., the polycrystalline Si substrate not formed with the oxide film but polished under the same condition as with the examples) had large steps which reflected differences in crystal orientation among crystal grains, as well as very poor waviness and microwaviness values. However, the comparative example had a low roughness because the surface was smooth when attention was focused on individual grains.

TABLE 1

| Films formed by spin coating | | | | | |
|---|---|---|---|---|---|
| and processing conditions | | | | | |
| | Coat | | | | |
| | thickness | Abrasion | Ra | Wa | μ-Wa |
| Organosilica | (nm) | wear (nm) | (nm) | (nm) | (nm) |
| Example 1: Accuflo T-27 | 100 | 50 | 0.20 | 0.26 | 0.29 |
| Example 2: Accuflo T-27 | 200 | 100 | 0.15 | 0.24 | 0.26 |
| Example 3: Accuglass P-5S | 400 | 250 | 0.10 | 0.25 | 0.25 |
| Example 4: Accuglass P-5S | 600 | 400 | 0.08 | 0.24 | 0.23 |
| Comparative Example: | 0 | 800 | 0.20 | 4.2 | 2.5 |
| No coat | | | | | |

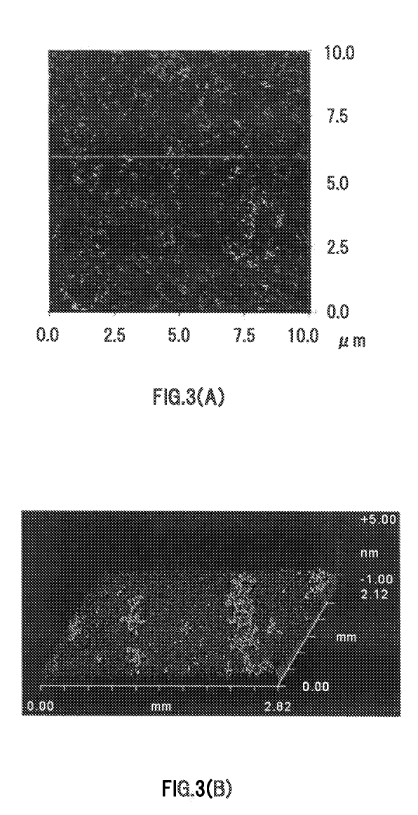

FIGS. 3(A) and 3(B) are each a graphic representation illustrating an exemplary evaluation of a polycrystalline Si substrate surface having been polished (subsequent to step S108) under the same condition noted above (polishing pressure: 5 kg/cm²); specifically, FIG. 3(A) illustrates the result of evaluation of a waviness and FIG. 3(B) illustrates the result of evaluation of a roughness.

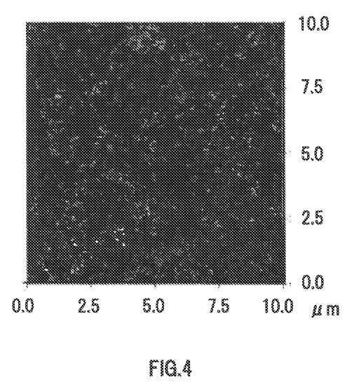

FIG. 4 is a graphic representation illustrating an exemplary evaluation of the waviness of a polycrystalline Si substrate surface obtained according to the method of the present invention. Specifically, FIG. 4 shows an example of an observed substrate surface obtained after having been subjected to a process including: scrubbing a polycrystalline Si substrate surface having undergone the rough polishing (step S106); subjecting the substrate surface to thermal oxidation at 1000° C. for one hour to form an oxide film having a thickness of 400 nm; and subjecting the oxide film to the same polishing as with example 3. Though the oxide film forming method differs from that used for the examples, substantially the same level of roughness (Ra=0.11 nm) can be attained.

The present invention makes it possible to provide an Si substrate for magnetic recording media which has a sufficient impact resistance, fails to complicate the fabrication process and the film forming process for a magnetic recording layer, exhibits an excellent surface planarity, and allows the cost to be reduced.

What is claimed is:

1. A silicon substrate for magnetic recording media, comprising: a polycrystalline silicon substrate having a purity of not less than 99.99%; and an oxide film formed over a major surface of the polycrystalline silicon substrate, wherein
the oxide film forms a substrate surface having a mean square waviness value and a mean square microwaviness value which are both not more than 0.3 nm.

2. A magnetic recording medium comprising: the silicon substrate according to claim 1; and a magnetic recording layer provided on the silicon substrate.

3. The silicon substrate for magnetic recording media according to claim 1, which has a diameter of not more than 90 mm.

4. A magnetic recording medium comprising: the silicon substrate according to claim 3; and a magnetic recording layer provided on the silicon substrate.

5. The silicon substrate for magnetic recording media according to claim 1, wherein the oxide film has a thickness of not more than 1,000 nm and not less than 10 nm.

6. A magnetic recording medium comprising: the silicon substrate according to claim 5; and a magnetic recording layer provided on the silicon substrate.

7. The silicon substrate for magnetic recording media according to claim 3, wherein the oxide film has a thickness of not more than 1,000 nm and not less than 10 nm.

8. A magnetic recording medium comprising: the silicon substrate according to claim 7; and a magnetic recording layer provided on the silicon substrate.

9. A method of fabricating a silicon substrate for magnetic recording media, comprising the steps of:
forming an oxide film over a major surface of a polycrystalline silicon substrate having a purity of not less than 99.99%; and
polishing the oxide film to planarize the oxide film, wherein
the oxide film forming step includes applying organic silica or a silicone material to the major surface of the polycrystalline silicon substrate by spin coating and then performing a heating treatment.

10. The method of fabricating a silicon substrate for magnetic recording media according to claim 9, wherein the polishing step includes subjecting the oxide film to a CMP process using a neutral or alkaline slurry so that a resulting substrate surface has a mean square waviness value and a mean square microwaviness value which are both not more than 0.3 nm.

11. A method of fabricating a silicon substrate for magnetic recording media, comprising the steps of:
forming an oxide film over a major surface of a polycrystalline silicon substrate having a purity of not less than 99.99%; and
polishing the oxide film to planarize the oxide film, wherein
the oxide film forming step includes thermally oxidizing the major surface of the polycrystalline silicon substrate.

12. The method of fabricating a silicon substrate for magnetic recording media according to claim 11, wherein the polishing step includes subjecting the oxide film to a CMP process using a neutral or alkaline slurry so that a resulting substrate surface has a mean square waviness value and a mean square microwaviness value which are both not more than 0.3 nm.
